(19) United States
(12) Patent Application Publication
(10) Pub. No.: US 2013/0173437 A1
(43) Pub. Date: Jul. 4, 2013

(54) Liquidity Assessment System

(71) Applicants: Maryfaith Capparell, West Caldwell, NJ (US); Brian J. Hascup, Allendale, NJ (US); James Kardell, Hellertown, PA (US); Itamar Gus, Tenafly, NJ (US); Jayalakshmi Balasubramanian, Jersey City, NJ (US); Julia Kirshtein, Mahwah, NJ (US); Amit A. Karve, Thane (IN); Kannan Pichai, Monmouth Junction, NJ (US); Ancilla Ambrose-Lourdes, Edison, NJ (US); Sara M. Cummings, Davidson, NC (US); Balaji Vadhiyar, Princeton, NJ (US); Steven F. Infuso, Bayonne, NJ (US)

(72) Inventors: Maryfaith Capparell, West Caldwell, NJ (US); Brian J. Hascup, Allendale, NJ (US); James Kardell, Hellertown, PA (US); Itamar Gus, Tenafly, NJ (US); Jayalakshmi Balasubramanian, Jersey City, NJ (US); Julia Kirshtein, Mahwah, NJ (US); Amit A. Karve, Thane (IN); Kannan Pichai, Monmouth Junction, NJ (US); Ancilla Ambrose-Lourdes, Edison, NJ (US); Sara M. Cummings, Davidson, NC (US); Balaji Vadhiyar, Princeton, NJ (US); Steven F. Infuso, Bayonne, NJ (US)

(73) Assignee: Bank of America Corporation, Charlotte, NC (US)

(21) Appl. No.: 13/343,140

(22) Filed: Jan. 4, 2012

(51) Int. Cl. G06Q 40/00

(52) U.S. Cl. 705/30

(57) ABSTRACT

In some embodiments, a liquidity assessment system comprises a memory and a processor communicatively coupled to the memory. The memory is operable to store financial environment data, financial liquidity data for a financial enterprise, and financial scenario data. The processor is configured to generate a scenario financial environment by applying the financial scenario data to the financial environment data, determine scenario liquidity positions for each financial entity within a financial enterprise, and compare the scenario liquidity positions with liquidity requirements of jurisdictions governing the financial entities.

### TECHNICAL FIELD

The present disclosure relates to financial liquidity and more specifically to a liquidity assessment system.

### BACKGROUND

Liquidity may refer to an asset's ability to be sold without causing a significant movement in the price and with minimum loss of value. Money, or cash in hand, is one example of a highly-liquid asset, which may be used to perform economic actions like buying, selling, or paying debt. An act of exchange of a less liquid asset with a more liquid asset is called liquidation. Assets with less liquidity may be subject to liquidity risk. Liquidity risk is a financial risk due to uncertain liquidity. For example, liquidity risk may include the risk that an asset cannot be traded quickly enough in the market to prevent a loss (or make a required profit).

Liquidity may also refer to an entity's ability to meet its payment obligations. An entity may have the ability to meet its payment obligations if the entity possesses sufficient liquid assets. The entity may also be subject to liquidity risk. For example, an entity may lose liquidity if its credit rating falls, it experiences sudden unexpected cash outflows (e.g., a “bank run”), or some other event causes counterparties to avoid trading with or lending to the financial entity. A financial entity may also be exposed to liquidity risk, for example, if markets on which it depends are subject to a loss of liquidity.

### SUMMARY

In some embodiments, a liquidity assessment system comprises a memory and a processor communicatively coupled to the memory. The memory is operable to store financial environment data, financial liquidity data for a financial enterprise, and financial scenario data. The processor is configured to generate a scenario financial environment by applying the financial scenario data to the financial environment data, determine scenario liquidity positions for each financial entity within a financial enterprise, and compare the scenario liquidity positions with liquidity requirements of jurisdictions governing the financial entities.

Certain embodiments may provide one or more technical advantages. A technical advantage of one embodiment may include the capability to assess liquidity across multiple financial entities subject to the regulations of different jurisdictions. A technical advantage of one embodiment may also include the capability to generate a global assessment of a financial enterprise by applying a scenario across multiple financial entities subject to the regulations of different jurisdictions. A technical advantage of one embodiment may also include the capability to satisfy reporting requirements of different jurisdictions.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its advantages, reference is now made to the following description taken in conjunction with the accompanying drawings, in which:

FIG. 1 shows a liquidity assessment system according to one embodiment;

FIG. 2 shows an example liquidity report according to one embodiment; and

FIG. 3 shows a method for assessing liquidity of a financial enterprise according to one example embodiment.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

An enterprise may include any individual, business, or organization. One example of an enterprise may include a financial enterprise. A financial enterprise may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A financial enterprise may provide a variety of financial products. Examples of financial products may include, but are not limited to, account services such as maintaining accounts, receiving deposits, crediting accounts, debiting accounts, extending credit, purchasing securities, providing insurance, and portfolio management.

A financial enterprise may be subject to a variety of rules and regulations. For example, some jurisdictions may promulgate liquidity requirements for any financial enterprise operating with the jurisdictions. These liquidity requirements may require the financial enterprise to maintain a certain level of liquidity. For example, the liquidity requirements may require the financial enterprise to maintain a certain level of liquidity globally or may require the financial enterprise to maintain a certain level of liquidity within the jurisdiction.

Jurisdictions may define liquidity requirements in a variety of ways. As one example, a jurisdiction may require stress testing of the financial enterprise's liquidity. Stress testing is a form of testing that may determine the stability of a given entity. Stress testing may include scenarios that are more severe than normal operational capacity. For example, financial stress testing may analyze how robust a financial enterprise is in certain types of market events.

Example types of stress testing scenarios may include extreme events, risk-factor shocks, and external-factor shocks. Extreme event scenarios may hypothesize the financial enterprise's return on its portfolios given the recurrence of a historical event. Extreme event scenarios may combine current positions and risk exposures with historical factor returns. Risk-factor shocks scenarios may shock any factor in the chosen risk model by a specified amount. External-factor shocks may shock any index, macro-economic series (e.g., oil prices), or custom series (e.g., exchange rates). Using regression analysis, new factor returns may be estimated as a result of the shock. Example stress test scenarios that fall in one or more of these example types may include the following prompts:
What happens if equity markets crash by more than x % this year?
What happens if interest rates go up by at least y %?
What if half the instruments in the portfolio terminate their contracts in the fifth year?
What happens if oil prices rise by 200%?

A financial enterprise may include entities in different jurisdictions. These different jurisdictions may impose different liquidity requirements on entities within their jurisdictions. Analyzing each financial entity individually, however, may not provide a satisfactory analysis of that financial entity's liquidity. For example, liquidity requirements of one jurisdiction may contemplate activities that occur outside that jurisdiction. As another example, financial entities within a financial enterprise may be related, and the performance of one financial entity within a jurisdiction may impact another financial entity outside the jurisdiction. As yet another example, analyzing each financial entity individually prevents the financial enterprise from performing global liquidity assessments. A global liquidity assessment may, for example, identify weak and strong entities and identify ways the financial enterprise may move assets among financial entities to satisfy various liquidity requirements. Accordingly, teachings of certain embodiments recognize the capability to assesses liquidity of a financial enterprise across multiple financial entities subject to liquidity requirements of multiple jurisdictions. Teachings of certain embodiments also recognize the capability to assess liquidity of the financial enterprise as a whole based on the liquidity of each financial entity within the financial enterprise.

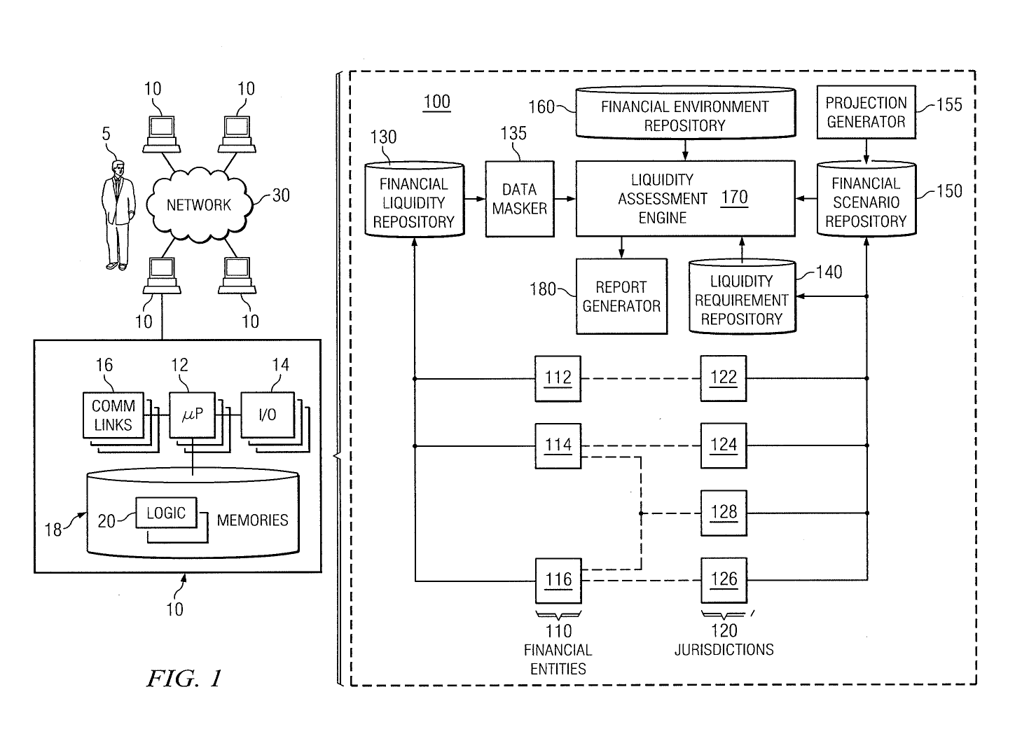

FIG. 1 shows a liquidity assessment system 100 according to one embodiment. The liquidity assessment system 100 of FIG. 1 features financial entities 110, jurisdictions 120, a financial liquidity repository 130, a liquidity requirement repository 140, a financial scenario repository 150, a projection generator 155, a financial environment repository 160, a liquidity assessment engine 170, and a report generator 180, that may be implemented by one or more computer systems 10.

Users 5 may access liquidity assessment system 100 through computer systems 10. Users 5 may include any individual, group of individuals, entity, machine, and/or mechanism that interacts with computer systems 10. Examples of users 5 include, but are not limited to, an analyst, manager, executive, review board, accountant, engineer, technician, contractor, agent, and/or employee. Users 5 may be associated with an organization such as a financial entity or a governing jurisdiction.

Computer system 10 may include processors 12, input/output devices 14, communications links 16, and memory 18. In other embodiments, computer system 10 may include more, less, or other components. Computer system 10 may be operable to perform one or more operations of various embodiments. Although the embodiment shown provides one example of computer system 10 that may be used with other embodiments, such other embodiments may utilize computers other than computer system 10. Additionally, embodiments may also employ multiple computer systems 10 or other computers networked together in one or more public and/or private computer networks, such as one or more networks 30.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable data between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any data for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

Various communications between computers 10 or components of computers 10 may occur across a network, such as network 30. Network 30 may represent any number and combination of wireline and/or wireless networks suitable for data transmission. Network 30 may, for example, communicate internet protocol packets, frame relay frames, asynchronous transfer mode cells, and/or other suitable data between network addresses. Network 30 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although the illustrated embodiment shows one network 30, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

Financial entities 110 represent legal entities associated with a financial enterprise. Financial entities 110 may include any entity capable of bearing legal rights and obligations, such as a natural person or an artificial person (e.g., business entity or corporate entity). In some circumstances, financial entities 110 may be legal entities under the control of a financial enterprise or otherwise have a contractual relationship with a financial enterprise. For example, financial entities 110 may be foreign subsidiaries of a financial enterprise based in the United States. As another example, financial entities 110 may be holding companies trusted with holding assets of a financial entity.

Jurisdictions 120 represent governing entities that enact and/or enforce liquidity requirements. Liquidity requirements are laws, regulations, and/or rules requiring financial entities 110 to maintain certain reserves of liquid assets. Liquid asset reserves may act as a liquidity buffer. A jurisdiction may require that each financial entity 110 maintain a minimum liquidity buffer. For example, jurisdiction 120 may require financial entities 110 to maintain a liquidity buffer value or minimum reserve ratio of liquid to non-liquid assets. Different jurisdictions 120 may require different amounts of reserves of liquid assets. Jurisdictions 120 may also use different definitions for what qualifies as a “reserve” and what qualifies as a “liquid” asset.

The example of FIG. 1 includes three financial entities 112, 114, and 116 and four jurisdictions 122, 124, 126, and 128. Other examples may include more or fewer financial entities 110 and jurisdictions 120. In this example, financial entity 112 is subject to liquidity restrictions of jurisdiction 122, financial entity 114 is subject to liquidity restrictions of jurisdictions 124 and 128, and financial entity 116 is subject to liquidity restrictions of 126 and 128.

Financial liquidity repository 130 stores liquidity positions for financial entities 110. In the example of FIG. 1, financial liquidity repository 130 receives liquidity positions from financial entities 112, 114, and 116. Liquidity positions may include any information that describes the liquidity of a financial entity 110. For example, liquidity positions may identify cash flow positions, such as projected future net cash flows based on current cash positions and future obligations. Liquidity positions may also identify trade positions, such as projected future trades based on current asset positions and future obligations. Liquidity positions may also include information identifying liquidity risks. For example, if financial entity 112 has offsetting cash flows with two different counterparties on a given day, the counterparty that owes a payment could default, forcing financial entity 112 to raise cash from other sources to make its payment. In this example, liquidity risk is compounding credit risk.

Liquidity positions may also identify relationships among financial entities 110. For example, one financial entity 110 may be able to minimize liquidity risk if the financial entity 110 is able to obtain liquid assets from other financial entities 110 within the financial enterprise. For example, if financial entity 112 suffers from a liquidity crisis, financial entity 114 may be able to provide liquid assets to financial entity 112. In some circumstances, however, financial entity 114 may not be able to provide liquid assets to financial entity 112 because financial entity 114 may also be suffering from a liquidity crisis for the same reasons as financial entity 112. Teachings of certain embodiments recognize that analyzing liquidity for multiple financial entities 110 within a financial enterprise may provide a more complete analysis of liquidity for any one financial entity 110 as compared to only analyzing liquidity for that one financial entity 110.

In some embodiments, system 100 may include a data masker 135. Data masker 135 may redact some information provided by financial liquidity repository 130. For example, some countries may require that counterparties be redacted. For example, if a financial entity owns certain stocks or has a trade agreement with a certain entity, data masker 135 may mask the identity of the counterparties. In these examples, liquidity assessment engine 170 may still be able to perform its liquidity assessment without knowing the exact identity of the various counterparties.

Liquidity requirement repository 140 stores liquidity requirements enacted and/or enforced by jurisdictions 120. In the example of FIG. 1, liquidity requirement repository 140 receives liquidity requirements from jurisdictions 122, 124, 126, and 128. In some circumstances, jurisdictions 120 may publish liquidity requirements, which may be reformatted for storage in liquidity requirement repository 140. For example, a jurisdiction 120 may promulgate regulations and publish texts stating the regulations. In this example, liquidity requirement repository 140 may store formulas that express the published liquidity requirements in mathematical form.

Financial scenario repository 150 stores financial scenario data. Financial scenario repository 150 stores information about theoretical future events. As one example, financial scenario repository 150 may store information identifying projected economic conditions (e.g., 15% of mortgage holders are projected to default in the next twelve months). As another example, financial scenario 150 may stress-testing scenarios that are more severe that projected economic conditions (e.g., 30% of mortgage holders are projected to default in the next twelve months). In some circumstances, scenarios may be unique to a particular financial entity 110 (e.g., a ratings agency may downgrade the credit rating of financial entity 124). In other circumstances, scenarios may apply to multiple financial entities (e.g., a ratings agency may downgrade the credit rating of jurisdiction 128, which may impact both financial entity 114 and 116).

Scenarios may be provided to financial scenario repository 150 from any suitable source. In some embodiments, financial entities 110 may create their own scenarios. For example, financial entities 110 may wish to project future events or stress test its own systems. In this example, financial entities 110 may create and/or input scenarios through projection generator 155. In some embodiments, projection generator 155 may provide a user interface for receiving scenarios.

In some embodiments, jurisdictions 120 may define scenarios. For example, jurisdictions 120 may require financial entities 110 to pass certain stress tests. In this example, financial scenario repository 150 may receive scenarios from jurisdictions 120. In some examples, user 5 may review scenarios provided by jurisdictions 120 and input them through projection generator 155.

Financial environment 160 stores information identifying an existing financial environment. Financial environment 160 may store financial information against which scenarios from financial scenario repository 150 may be compared. For example, a scenario from financial scenario repository 150 may change one or more characteristics of an existing financial environment. For example, financial environment repository 160 may indicate that the three-month London Interbank Offered Rate (LIBOR) is currently 0.34%. In this example, a stress-test scenario from financial scenario repository 150 may increase the three-month LIBOR rate to 1.05% for purposes of the scenario.

Liquidity assessment engine 170 assesses the liquidity of financial entities 110 by comparing the financial entity's liquidity to the liquidity requirements of jurisdiction 120. In some examples, liquidity assessment engine 170 compares existing liquidity positions of financial entity 110 to the liquidity requirements of jurisdiction 120. In other examples, liquidity assessment engine 170 compares performance of financial entity 110 in a scenario to the liquidity requirements of jurisdiction 120.

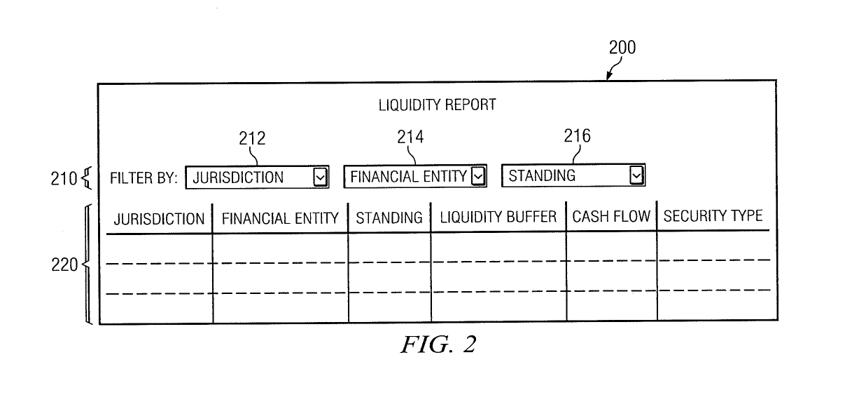

Report generator 180 generates liquidity reports. Liquidity reports may present the results of the liquidity assessment from liquidity assessment engine 170, as well as information used by liquidity assessment engine 170 (e.g., liquidity positions, scenario criteria, etc.). Liquidity reports may be organized in any suitable manner. For example, a liquidity report may be specific to a particular jurisdiction 120, such as providing information on every financial entity 110 within the financial enterprise that is subject to the liquidity requirements of the particular jurisdiction 120. As another example, a liquidity report may be specific to a particular financial entity 110, such as providing information on the particular financial entity's compliance with the liquidity requirements of every governing jurisdiction 120. An example of a liquidity report is described in greater detail with regards to FIG. 2.

In operation, according to one example embodiment, liquidity assessment engine 170 assesses whether financial entity 114 is currently in compliance with the liquidity requirements of jurisdictions 124 and 128. In this example, jurisdictions 124 and 128 promulgate different sets of stress tests that must be satisfied.

In this example embodiment, financial environment repository 160 stores information regarding an existing financial environment (e.g., existing interest rates, market conditions, etc.). Financial entity 114 provides liquidity positions to financial liquidity repository 130. These liquidity positions identify the existing liquidity positions of financial entity 114 in the existing financial environment.

Liquidity requirement repository 140 receives the liquidity requirements from jurisdictions 124 and 128. In this example, the liquidity requirements include stress tests that must be satisfied. Jurisdictions 124 and 128 provide scenarios to financial scenario repository 150 that set forth the parameters of the stress tests (e.g., a change to at least one characteristic of the existing financial environment stored in financial environment repository 160). Jurisdictions 124 and 128 also provide liquidity requirements to liquidity requirement repository 140 that set forth how well financial entity 114 must perform under the stress tests.

Liquidity assessment engine 170 applies the scenarios provided by jurisdictions 124 and 128 to the existing financial environment stored in financial environment repository 160 to yield a scenario financial environment. Next, liquidity assessment engine 170 determines a scenario liquidity position for financial entity 114. For example, liquidity assessment engine 170 may calculate how the liquidity positions received from financial entity 114 would change in the scenario financial environment. Liquidity assessment engine 170 then compares the scenario liquidity position with the liquidity requirements received from jurisdictions 124 and 128 to determine whether financial entity 114 satisfies the liquidity requirements.

FIG. 2 shows an example liquidity report 200 according to one embodiment. Liquidity report 200 includes filters 210 and a table 220. Filters 210 allow user 5 to select information to be included in table 220. In the example of FIG. 2, liquidity report 200 includes three filters 210: jurisdiction filter 212, financial entity filter 214, and standing filter 216. Jurisdiction filter 212 allows user 5 to limit the information shown in table 220 to jurisdictions selected from among jurisdictions 120. Financial entity filter 214 allows user 5 to limit the information shown in table 220 to particular financial entities selected from among financial entities 110. Standing filter 116 allows user 5 to limit the information shown in table 220 to financial entities with various liquidity standings. For example, user 5 may limit the information shown to those financial entities that are not currently in compliance with governing liquidity restrictions. As another example, user 5 may limit the information shown to those financial entities that have excess liquidity available.

Table 220 presents liquidity information to user 5. In the example of FIG. 2, table 220 includes columns for “Jurisdiction,” “Financial Entity,” “Standing,” “Liquidity Buffer,” “Cash Flow,” and “Security Type.” The Liquidity Buffer column indicates the amount of liquidity reserves a financial entity has available. The Cash Flow column indicates projected cash flow for a financial entity.

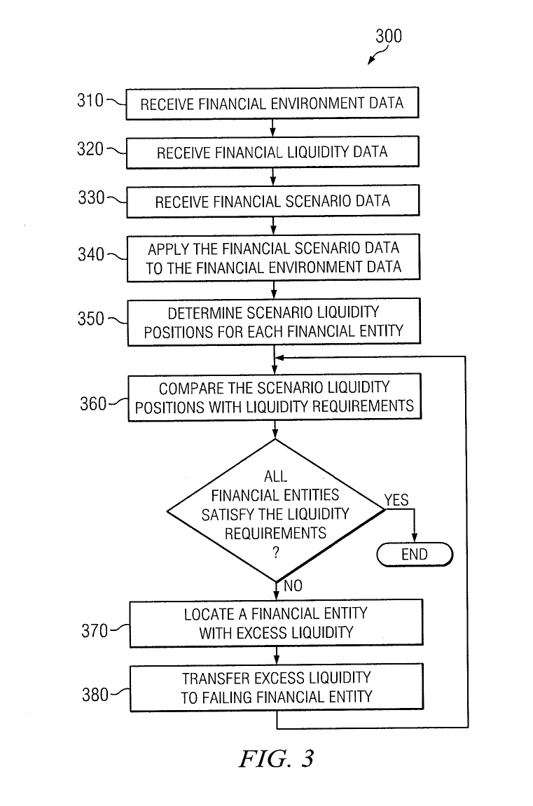

FIG. 3 shows a method 300 for assessing liquidity of a financial enterprise according to one example embodiment. At step 310, financial environment data is received. The financial environment data identifies at least one characteristic of an existing financial environment. At step 320, financial liquidity data is received regarding each financial entity within a financial enterprise. In this example, each financial entity is subject to the liquidity requirements of one or more jurisdictions. At step 330, financial scenario data is received. The financial scenario data identifies at least one change to the at least one characteristic of the existing financial environment. For example, the financial scenario data may change market interest rates, the price of oil, or sovereign credit ratings.

At step 340, the financial scenario data is applied to the financial environment data to yield a scenario financial environment. At step 350, scenario liquidity positions are determined for each financial entity within the financial enterprise. Step 350 may determine, for example, what liquidity positions would be in a world with changed market interest rates, price of oil, or sovereign credit ratings. At step 360, the scenario liquidity positions are compared to the liquidity requirements of each governing jurisdiction. If every financial entity within the financial enterprise satisfies the liquidity requirements, the method ends. If a financial entity does not satisfy the liquidity requirements of a governing jurisdiction, another financial entity with excess liquidity is located at step 370. At step 380, the excess liquidity is transferred to the failing financial entity. The method then returns to step 360 and repeats until every financial entity associated with a financial enterprise satisfies the liquidity requirements.

In the example of FIG. 3, transferring liquidity between financial entities may resolve liquidity problems. Teachings of certain embodiments recognize, however, that a variety of actions may be taken to resolve liquidity problems. For example, a financial entity may sell non-liquid or low-liquid assets in exchange for highly-liquid assets.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

What is claimed is:

1. A liquidity assessment system, comprising:
a memory operable to store:
financial environment data, the financial environment data identifying at least one characteristic of an existing financial environment;
financial liquidity data for a financial enterprise, the financial enterprise comprising a plurality of financial entities, the plurality of financial entities comprising a first financial entity and a second financial entity, the first financial entity being subject to liquidity requirements of a first jurisdiction, the second financial entity being subject to liquidity requirements of a second jurisdiction different from the first jurisdiction, the financial liquidity data identifying a liquidity position for each financial entity in the existing financial environment;
financial scenario data, the financial scenario data identifying at least one change to the at least one characteristic of the existing financial environment; and
a processor, communicatively coupled to the memory, the processor configured to:
generate a scenario financial environment by applying the financial scenario data to the financial environment data;
determine a first scenario liquidity position for the first financial entity in the scenario financial environment;
determine a second scenario liquidity position for the second financial entity in the scenario financial environment;
compare the first scenario liquidity position to the liquidity requirements of the first jurisdiction; and
compare the second scenario liquidity position to the liquidity requirements of the second jurisdiction.

2. The system of claim 1, wherein the financial liquidity data identifies cash flow positions for each financial entity in the existing financial environment.

3. The system of claim 1, wherein the financial liquidity data identifies trade positions for each financial entity in the existing financial environment.

4. The system of claim 1, wherein the first financial entity is also subject to the liquidity requirements of the second jurisdiction, the processor further configured to compare the first scenario liquidity position to the liquidity requirements of the second jurisdiction.

5. The system of claim 1, wherein the liquidity requirements of the first jurisdiction indicate the at least one change to the at least one characteristic of the existing financial environment.

6. The system of claim 1, the processor being further configured to generate a first jurisdiction report, the first jurisdiction report comprising a scenario liquidity position for each financial entity of the plurality of financial entities subject to the liquidity requirements of the first jurisdiction.

7. The system of claim 1, wherein the liquidity requirements of the first jurisdiction and the second jurisdiction comprise liquidity buffer requirements, the liquidity buffer requirements defining a minimum liquidity buffer required for a financial entity.

8. A non-transitory computer readable medium comprising logic for execution, the logic, when executed by a processor, operable to:
receive financial environment data, the financial environment data identifying at least one characteristic of an existing financial environment;
receive financial liquidity data for a financial enterprise, the financial enterprise comprising a plurality of financial entities, the plurality of financial entities comprising a first financial entity and a second financial entity, the first financial entity being subject to liquidity requirements of a first jurisdiction, the second financial entity being subject to liquidity requirements of a second jurisdiction different from the first jurisdiction, the financial liquidity data identifying a liquidity position for each financial entity in the existing financial environment;
receive financial scenario data, the financial scenario data identifying at least one change to the at least one characteristic of the existing financial environment;
generate a scenario financial environment by applying the financial scenario data to the financial environment data;
determine a first scenario liquidity position for the first financial entity in the scenario financial environment;
determine a second scenario liquidity position for the second financial entity in the scenario financial environment;
compare the first scenario liquidity position to the liquidity requirements of the first jurisdiction; and
compare the second scenario liquidity position to the liquidity requirements of the second jurisdiction.

9. The computer-readable medium of claim 8, wherein the financial liquidity data identifies cash flow positions for each financial entity in the existing financial environment.

10. The computer-readable medium of claim 8, wherein the financial liquidity data identifies trade positions for each financial entity in the existing financial environment.

11. The computer-readable medium of claim 8, wherein the first financial entity is also subject to the liquidity requirements of the second jurisdiction, the logic when executed being further operable to compare the first scenario liquidity position to the liquidity requirements of the second jurisdiction.

12. The computer-readable medium of claim 8, wherein the liquidity requirements of the first jurisdiction indicate the at least one change to the at least one characteristic of the existing financial environment.

13. The computer-readable medium of claim 8, the logic when executed being further operable to generate a first jurisdiction report, the first jurisdiction report comprising a scenario liquidity position for each financial entity of the plurality of financial entities subject to the liquidity requirements of the first jurisdiction.

14. The computer-readable medium of claim 8, wherein the liquidity requirements of the first jurisdiction and the second jurisdiction comprise liquidity buffer requirements, the liquidity buffer requirements defining a minimum liquidity buffer required for a financial entity.

15. A method for assessing liquidity of a financial enterprise, comprising:
receiving financial environment data, the financial environment data identifying at least one characteristic of an existing financial environment;
receiving financial liquidity data for a financial enterprise, the financial enterprise comprising a plurality of financial entities, the plurality of financial entities comprising a first financial entity and a second financial entity, the first financial entity being subject to liquidity requirements of a first jurisdiction, the second financial entity being subject to liquidity requirements of a second jurisdiction different from the first jurisdiction, the financial liquidity data identifying a liquidity position for each financial entity in the existing financial environment;
receiving financial scenario data, the financial scenario data identifying at least one change to the at least one characteristic of the existing financial environment;
generating a scenario financial environment by applying the financial scenario data to the financial environment data;
determining a first scenario liquidity position for the first financial entity in the scenario financial environment;
determining a second scenario liquidity position for the second financial entity in the scenario financial environment;
comparing the first scenario liquidity position to the liquidity requirements of the first jurisdiction; and
comparing the second scenario liquidity position to the liquidity requirements of the second jurisdiction.

16. The method of claim 15, wherein the financial liquidity data identifies cash flow positions for each financial entity in the existing financial environment.

17. The method of claim 15, wherein the financial liquidity data identifies trade positions for each financial entity in the existing financial environment.

18. The method of claim 15, wherein the first financial entity is also subject to the liquidity requirements of the second jurisdiction, the method further comprising comparing the first scenario liquidity position to the liquidity requirements of the second jurisdiction.

19. The method of claim 15, wherein the liquidity requirements of the first jurisdiction indicate the at least one change to the at least one characteristic of the existing financial environment.

20. The method of claim 15, wherein the liquidity requirements of the first jurisdiction and the second jurisdiction comprise liquidity buffer requirements, the liquidity buffer requirements defining a minimum liquidity buffer required for a financial entity.
